(19) United States
(12) Patent Application Publication
(10) Pub. No.: US 2024/0105389 A1
(43) Pub. Date: Mar. 28, 2024

(54) WOUND CAPACITOR PACKAGE STRUCTURE AND METHOD OF MANUFACTURING THE SAME

(71) Applicant: APAQ TECHNOLOGY CO., LTD., MIAOLI COUNTY (TW)

(72) Inventors: MING-TSUNG LIANG, NEW TAIPEI CITY (TW); HSUAN-YI LIN, TAICHUNG CITY (TW)

(21) Appl. No.: 18/079,977

(22) Filed: Dec. 13, 2022

(30) Foreign Application Priority Data
Sep. 28, 2022 (TW) 111136633

(51) Int. Cl. H01G 4/224; H01G 4/236; H01G 4/32

(52) U.S. Cl. CPC H01G 4/224; H01G 4/236; H01G 4/32

(57) ABSTRACT

A wound capacitor package structure and a method of manufacturing the same are provided. The wound capacitor package structure includes a wound assembly, a conductive assembly, a package casing and a protruding sealing element. The conductive assembly includes a first conductive pin and a second conductive pin. The package casing is configured to receive the wound assembly. The protruding sealing element is arranged inside and cooperates with the package casing. The package casing is configured to receive the wound assembly. The protruding sealing element is disposed inside the package casing and cooperating with the package casing. The package casing has a surrounding concave position-limiting portion recessed inward, and a surrounding convex end portion protruding from the surrounding concave position-limiting portion. The protruding sealing element has a main sealing portion pressed by the surrounding concave position-limiting portion, and an auxiliary sealing portion protruding from the main sealing portion.

### CROSS-REFERENCE TO RELATED PATENT APPLICATION

This application claims the benefit of priority to Taiwan Patent Application No. 111136633, filed on Sep. 28, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a capacitor package structure and a method of manufacturing the same, and more particularly to a wound capacitor package structure and a method of manufacturing the same.

### BACKGROUND OF THE DISCLOSURE

Various applications of capacitors include being used in home appliances, computer motherboards and peripherals, power supplies, communication products and automobiles. Capacitors such as solid electrolytic capacitors are mainly used to provide functions such as filtering, bypassing, rectifying, coupling, blocking and transforming. However, there is still room for improvement in the related art of the winding capacitor.

### SUMMARY OF THE DISCLOSURE

In response to the above-referenced technical inadequacy, the present disclosure provides a wound capacitor package structure and a method of manufacturing the same.

In order to solve the above-mentioned problems, one of the technical aspects adopted by the present disclosure is to provide a wound capacitor package structure, which includes a wound assembly, a conductive assembly, a package casing and a protruding sealing element. The wound assembly includes a wound positive conductive foil, a wound negative conductive foil and two wound insulating separators. The conductive assembly includes a first conductive pin electrically contacting the wound positive conductive foil and a second conductive pin electrically contacting the wound negative conductive foil. The package casing is configured to receive the wound assembly. The protruding sealing element is disposed inside the package casing and cooperating with the package casing. One of the two wound insulating separators is disposed between the wound positive conductive foil and the wound negative conductive foil, and one of the wound positive conductive foil and the wound negative conductive foil is disposed between the two wound insulating separators. The first conductive pin includes a first embedded portion accommodated inside the package casing and covered by the protruding sealing element, and a first exposed portion exposed outside the package casing, and the second conductive pin includes a second embedded portion accommodated inside the package casing and covered by the protruding sealing element, and a second exposed portion exposed outside the package casing. The package casing has a surrounding concave position-limiting portion recessed inward to press the protruding sealing element, and a surrounding convex end portion protruding from the surrounding concave position-limiting portion to abut against the protruding sealing element. The protruding sealing element has a main sealing portion pressed by the surrounding concave position-limiting portion and abutted by the surrounding convex end portion, and an auxiliary sealing portion protruding from the main sealing portion and surrounded by the surrounding convex end portion. A maximum height of the auxiliary sealing portion relative to the main sealing portion is less than or equal to a maximum height of the surrounding convex end portion relative to the main sealing portion.

In order to solve the above-mentioned problems, another one of the technical aspects adopted by the present disclosure is to provide a wound capacitor package structure, which includes a wound assembly, a conductive assembly, a package casing and a protruding sealing element. The conductive assembly includes a first conductive pin electrically contacting the wound assembly and a second conductive pin electrically contacting the wound assembly. The package casing is configured to receive the wound assembly. The protruding sealing element is disposed inside the package casing and cooperating with the package casing. The package casing has a surrounding concave position-limiting portion recessed inward to press the protruding sealing element, and a surrounding convex end portion protruding from the surrounding concave position-limiting portion to abut against the protruding sealing element. The protruding sealing element has a main sealing portion pressed by the surrounding concave position-limiting portion and abutted by the surrounding convex end portion, and an auxiliary sealing portion protruding from the main sealing portion and surrounded by the surrounding convex end portion.

In order to solve the above-mentioned problems, yet another one of the technical aspects adopted by the present disclosure is to provide a method of manufacturing a wound capacitor package structure, which includes: providing a wound assembly and a conductive assembly, in which the conductive assembly includes a first conductive pin electrically contacting the wound assembly and a second conductive pin electrically contacting the wound assembly; determining whether a placement orientation of a protruding sealing element is correct; passing the protruding sealing element in the correct placement orientation by the first conductive pin and the second conductive pin of the conductive assembly, and completely accommodating the wound assembly and the protruding sealing element inside a package casing; and changing a shape of the package casing so as to allow the package casing to cooperate with the protruding sealing element. The package casing has a surrounding concave position-limiting portion recessed inward to press the protruding sealing element, and a surrounding convex end portion protruding from the surrounding concave position-limiting portion to abut against the protruding sealing element. The protruding sealing element has a main sealing portion pressed by the surrounding concave position-limiting portion and abutted by the surrounding convex end portion, and an auxiliary sealing portion protruding from the main sealing portion and surrounded by the surrounding convex end portion.

In one of the possible or preferred embodiments, the step of determining whether the placement orientation of the protruding sealing element is correct further includes: by an image capture system, capturing an image of the protruding sealing element; and by an image recognition system, determining whether the auxiliary sealing portion of the protruding sealing element is arranged upward or downward, or determining whether the auxiliary sealing portion is located above the main sealing portion or below the main sealing portion. If the auxiliary sealing portion of the protruding sealing element is arranged upward, or the auxiliary sealing portion is located above the main sealing portion, the image recognition system is configured to determine the placement orientation of the protruding sealing element is correct. If the auxiliary sealing portion of the protruding sealing element is arranged downward, or the auxiliary sealing portion is located below the main sealing portion, the image recognition system is configured to determine the placement orientation of the protruding sealing element is wrong. If the image recognition system is configured to determine the placement orientation of the protruding sealing element is wrong, the protruding sealing element is turned over by 180 degrees, and then the step of determining whether the placement orientation of the protruding sealing element is correct is performed again. In the step of passing the protruding sealing element in the correct placement orientation by the first conductive pin and the second conductive pin of the conductive assembly, both the first conductive pin and the second conductive pin of the conductive assembly pass through the main sealing portion and the auxiliary sealing portion of the protruding sealing element in sequence.

In one of the possible or preferred embodiments, the package casing has an opening, and the protruding sealing element is disposed at the opening of the package casing so as to close the opening of the package casing. The auxiliary sealing portion of the protruding sealing element does not be pressed by the surrounding concave position-limiting portion of the package casing and does not contact the surrounding convex end portion of the package casing, so that the main sealing portion of the protruding sealing element is deformed through the package casing, and the auxiliary sealing portion of the protruding sealing element is not deformed through the package casing. A minimum width of the surrounding convex end portion of the package casing is smaller than a maximum width of the auxiliary sealing portion of the protruding sealing element. A thickness of the main sealing portion of the protruding sealing element is greater than a thickness of the auxiliary sealing portion of the protruding sealing element. The surrounding convex end portion of the package casing is closer to the auxiliary sealing portion of the protruding sealing element than the surrounding concave position-limiting portion of the package casing. The surrounding convex end portion of the package casing is surroundingly disposed on the main sealing portion of the protruding sealing element to form a recessed space, and the auxiliary sealing portion of the protruding sealing element is completely accommodated inside the recessed space to occupy 70% to 100% of the recessed space. The main sealing portion of the protruding sealing element is closer to the wound assembly than the auxiliary sealing portion of the protruding sealing element, so that a height of the main sealing portion of the protruding sealing element relative to the wound assembly is smaller than a height of the auxiliary sealing portion of the protruding sealing element relative to the wound assembly. A maximum height of the auxiliary sealing portion relative to the main sealing portion is less than or equal to a maximum height of the surrounding convex end portion relative to the main sealing portion.

In one of the possible or preferred embodiments, the first conductive pin includes a first embedded portion accommodated inside the package casing and covered by the protruding sealing element, and a first exposed portion exposed outside the package casing, and the second conductive pin includes a second embedded portion accommodated inside the package casing and covered by the protruding sealing element, and a second exposed portion exposed outside the package casing. The first embedded portion of the first conductive pin has a first large-diameter section covered by the main sealing portion of the protruding sealing element, and a first small-diameter section covered by the auxiliary sealing portion of the protruding sealing element, the first large-diameter section of the first embedded portion extends from the wound assembly, the first small-diameter section is connected between the first large-diameter section and the first exposed portion, and a diameter of the first large-diameter section is larger than a diameter of the first small-diameter section. The second embedded portion of the second conductive pin has a second large-diameter section covered by the main sealing portion of the protruding sealing element, and a second small-diameter section covered by the auxiliary sealing portion of the protruding sealing element, the second large-diameter section of the second embedded portion extends from the wound assembly, the second small-diameter section is connected between the second large-diameter section and the second exposed portion, and a diameter of the second large-diameter section is larger than a diameter of the second small-diameter section. The main sealing portion has a first large-diameter through hole, the auxiliary sealing portion has a first small-diameter through hole communicated with the first large-diameter through hole, an inner diameter of the first large-diameter through hole of the main sealing portion is larger than an inner diameter of the first small-diameter through hole of the auxiliary sealing portion, the first large-diameter through hole of the main sealing portion and the first small-diameter through hole of the auxiliary sealing portion are respectively configured to accommodate the first large-diameter section and the first small-diameter section of the first embedded portion, and the diameter of the first large-diameter section of the first embedded portion is larger than the inner diameter of the first small-diameter through hole of the auxiliary sealing portion, so that the first large-diameter section of the first embedded portion is unable to be inserted into the first small-diameter through hole of the auxiliary sealing portion and is blocked outside the first small-diameter through hole of the auxiliary sealing portion. The main sealing portion has a second large-diameter through hole, the auxiliary sealing portion has a second small-diameter through hole communicated with the second large-diameter through hole, an inner diameter of the second large-diameter through hole of the main sealing portion is larger than an inner diameter of the second small-diameter through hole of the auxiliary sealing portion, the second large-diameter through hole of the main sealing portion and the second small-diameter through hole of the auxiliary sealing portion are respectively configured to accommodate the second large-diameter section and the second small-diameter section of the second embedded portion, and the diameter of the second large-diameter section of the second embedded portion is larger than the inner diameter of the second small-diameter through hole of the auxiliary sealing portion, so that the second large-diameter section of the second embedded portion is unable to be inserted into the second small-diameter through hole of the auxiliary sealing portion and is blocked outside the second small-diameter through hole of the auxiliary sealing portion.

Therefore, in the wound capacitor package structure provided by the present disclosure, by virtue of “the package casing having a surrounding concave position-limiting portion recessed inward to press the protruding sealing element, and a surrounding convex end portion protruding from the surrounding concave position-limiting portion to abut against the protruding sealing element” and “the protruding sealing element having a main sealing portion pressed by the surrounding concave position-limiting portion and abutted by the surrounding convex end portion, and an auxiliary sealing portion protruding from the main sealing portion and surrounded by the surrounding convex end portion,” the auxiliary sealing portion can provide an additional thickness to the protruding sealing element (that is to say, the total thickness of the protruding sealing element includes the thickness of the main sealing portion and the thickness of the auxiliary sealing portion), whereby the wound capacitor package structure has higher heat resistance during the reflow process due to the protection of the protruding sealing element (that is to say, the wound assembly has higher heat resistance during the reflow process due to the protection of the protruding sealing element). It is worth noting that when the thickness of the main sealing portion is reduced, the auxiliary sealing portion can still provide sufficient thickness, so that the overall height of the wound capacitor package structure (or the overall height of the package casing) can be reduced.

Furthermore, in the method of manufacturing the wound capacitor package structure provided by the present disclosure, by virtue of “determining whether a placement orientation of a protruding sealing element is correct,” “passing the protruding sealing element in the correct placement orientation by the first conductive pin and the second conductive pin of the conductive assembly until the protruding sealing element is completely accommodated inside a package casing,” “the package casing having a surrounding concave position-limiting portion recessed inward to press the protruding sealing element, and a surrounding convex end portion protruding from the surrounding concave position-limiting portion to abut against the protruding sealing element” and “the protruding sealing element having a main sealing portion pressed by the surrounding concave position-limiting portion and abutted by the surrounding convex end portion, and an auxiliary sealing portion protruding from the main sealing portion and surrounded by the surrounding convex end portion,” the auxiliary sealing portion can provide an additional thickness to the protruding sealing element (that is to say, the total thickness of the protruding sealing element includes the thickness of the main sealing portion and the thickness of the auxiliary sealing portion), whereby the wound capacitor package structure has higher heat resistance during the reflow process due to the protection of the protruding sealing element (that is to say, the wound assembly has higher heat resistance during the reflow process due to the protection of the protruding sealing element). It is worth noting that when the thickness of the main sealing portion is reduced, the auxiliary sealing portion can still provide sufficient thickness, so that the overall height of the wound capacitor package structure (or the overall height of the package casing) can be reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method of manufacturing a wound capacitor package structure according to a first embodiment of the present disclosure;

FIG. 2 is a schematic view of step S100 of the method of manufacturing the wound capacitor package structure according to the first embodiment of the present disclosure;

FIG. 3 is a schematic view of step S102 of the method of manufacturing the wound capacitor package structure according to the first embodiment of the present disclosure;

FIG. 4 is a schematic view of step S104 (including passing the protruding sealing element in the correct placement orientation by the first conductive pin and the second conductive pin of the conductive assembly) of the method of manufacturing the wound capacitor package structure according to the first embodiment of the present disclosure;

FIG. 5 is a schematic view of step S104 (including completely accommodating the wound assembly and the protruding sealing element inside a package casing) of the method of manufacturing the wound capacitor package structure according to the first embodiment of the present disclosure;

FIG. 6 is a schematic view of the wound capacitor package structure according to the first embodiment of the present disclosure; and

FIG. 7 is a schematic view of the wound capacitor package structure according to a second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

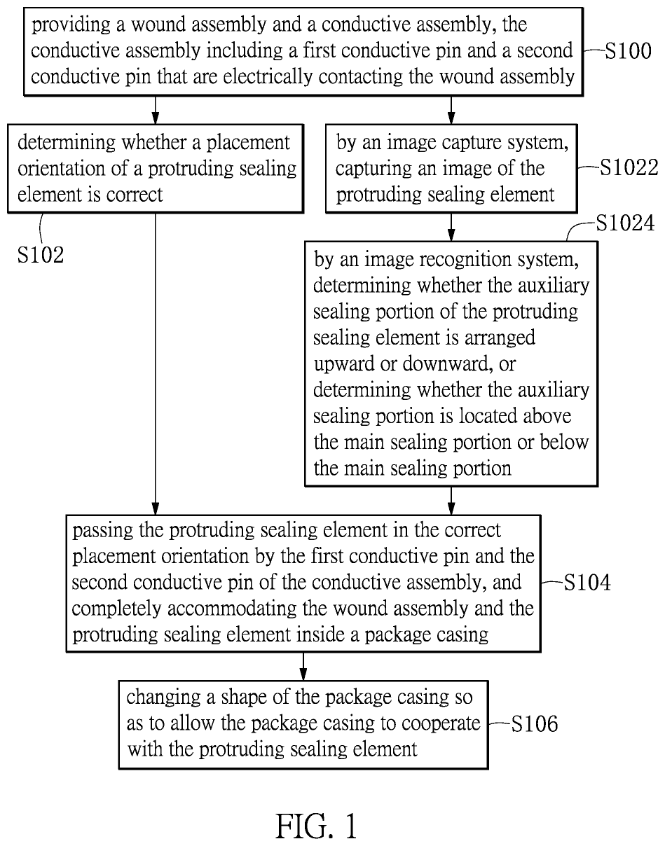

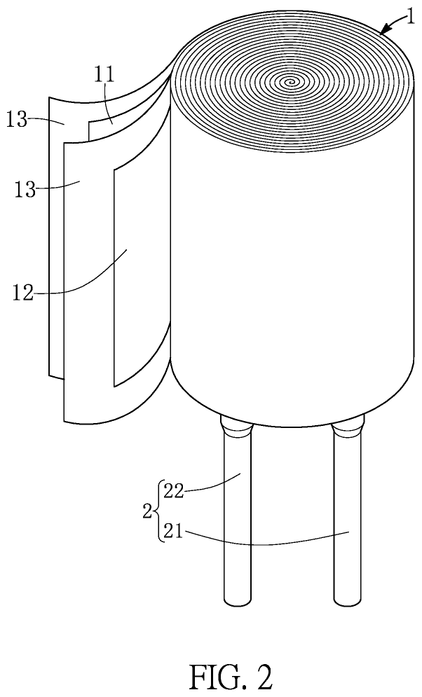

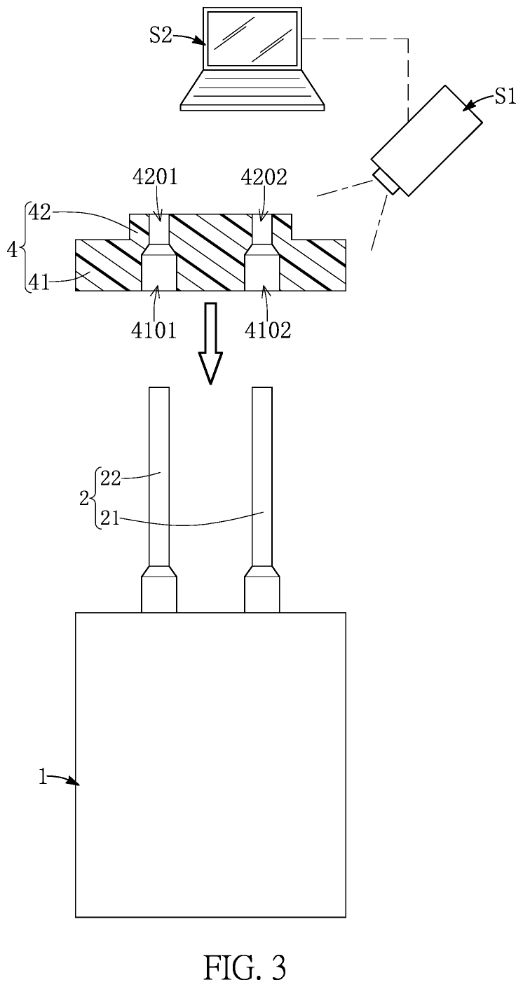

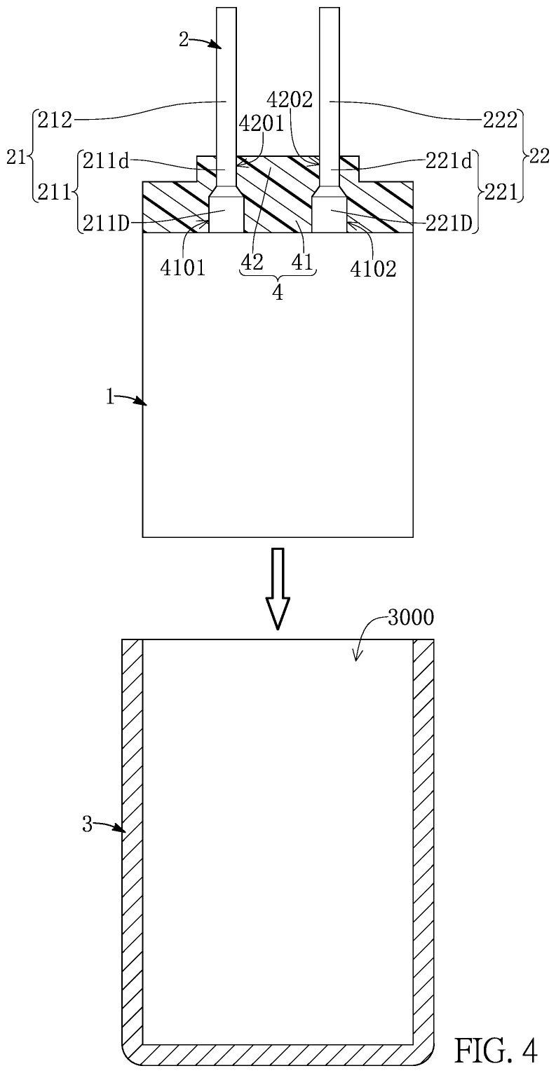

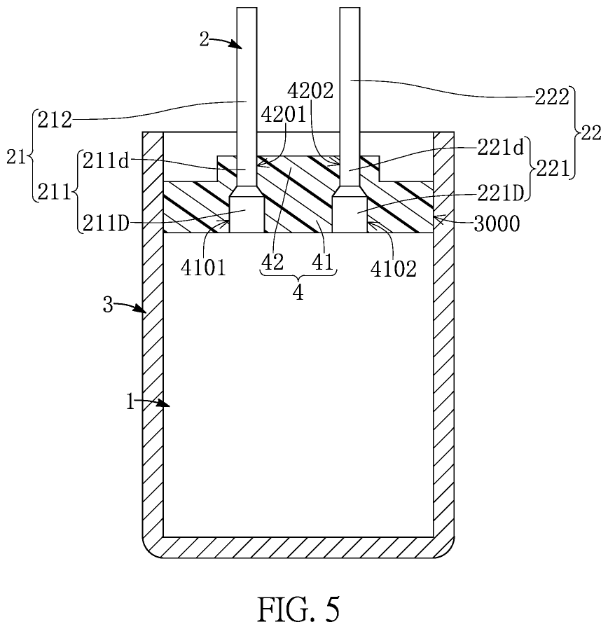

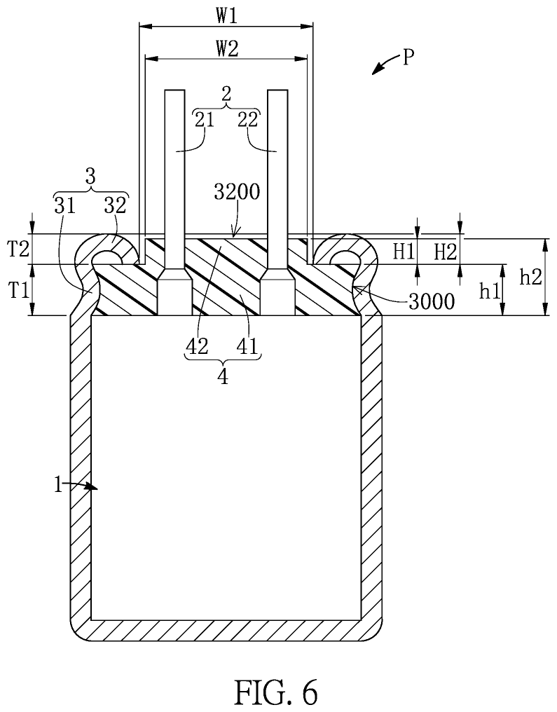

Referring to FIG. 1 to FIG. 6, a first embodiment of the present disclosure provides a method of manufacturing a wound capacitor package structure P (i.e., a winding-type capacitor package structure), which at least includes: firstly, referring to FIG. 1 and FIG. 2, providing a wound assembly 1 and a conductive assembly 2, in which the conductive assembly 2 includes a first conductive pin 21 electrically contacting the wound assembly 1 and a second conductive pin 22 electrically contacting the wound assembly 1 (step S100); next, referring to FIG. 1 and FIG. 3, determining whether a placement orientation of a protruding sealing element 4 (or a convex sealing structure) is correct (step S102); then, referring to FIG. 1, FIG. 4 and FIG. 5, passing the protruding sealing element 4 in the correct placement orientation by the first conductive pin 21 and the second conductive pin 22 of the conductive assembly 2, and completely accommodating the wound assembly 1 and the protruding sealing element 4 inside a package casing 3 (step S104); and referring to FIG. 1, FIG. 5 and FIG. 6, changing a shape of the package casing 3 so as to allow the package casing 3 to cooperate with the protruding sealing element 4 (step S106). Therefore, as shown in FIG. 6, in the first embodiment of the present disclosure, a winding capacitor packaging structure P can be fabricated by using a method for manufacturing the winding capacitor packaging structure. The wound capacitor package structure P includes a wound assembly 1, a conductive assembly 2, a package casing 3 (or an encapsulating casing) and a protruding sealing element 4. More particularly, the conductive assembly 2 includes a first conductive pin 21 electrically contacting the wound assembly 1 and a second conductive pin 22 electrically contacting the wound assembly 1, the package casing 3 can be configured to receive the wound assembly 1, and the protruding sealing element 4 can be disposed inside the package casing 3 and cooperate with the package casing 3. Moreover, the package casing 3 has a surrounding concave position-limiting portion 31 that is recessed inward to press the protruding sealing element 4, and a surrounding convex end portion 32 that is protruding from the surrounding concave position-limiting portion 31 to abut against the protruding sealing element 4. In addition, the protruding sealing element 4 has a main sealing portion 41 that is pressed by the surrounding concave position-limiting portion 31 and abutted by the surrounding convex end portion 32, and an auxiliary sealing portion 42 that is protruding from the main sealing portion 41 and surrounded by the surrounding convex end portion 32.

For example, referring to FIG. 1 and FIG. 2, in the step S100 of providing the wound assembly 1 and the conductive assembly 2, the wound assembly 1 includes a wound positive conductive foil 11, a wound negative conductive foil 12 and two wound insulating separators 13. More particularly, one of the two wound insulating separators 13 can be disposed between the wound positive conductive foil 11 and the wound negative conductive foil 12, and one of the wound positive conductive foil 11 and the wound negative conductive foil 12 is disposed between the two wound insulating separators 13 (for example, as shown in FIG. 2, the wound positive conductive foil 11 is disposed between the two wound insulating separators 13). In addition, the wound insulating separator 13 can be an insulating paper or insulating foil containing a dipping material such as conductive polymer. However, the aforementioned details are disclosed for exemplary purposes only, and are not meant to limit the scope of the present disclosure.

For example, referring to FIG. 1 and FIG. 3, in the step S102 of determining whether the placement orientation of the protruding sealing element 4 is correct further includes: firstly, by an image capture system S1 (such as CCD or COMS), capturing an image of the protruding sealing element 4 (step S1022); then, by an image recognition system S2 (such as a computer or any image processor), determining whether the auxiliary sealing portion 42 of the protruding sealing element 4 is arranged upward (as shown in FIG. 3) or downward (i.e., inverting the auxiliary sealing portion 42 as shown in FIG. 3), or determining whether the auxiliary sealing portion 42 is located above the main sealing portion 41 (as shown in FIG. 3) or below the main sealing portion 41 (i.e., inverting the auxiliary sealing portion 42 as shown in FIG. 3) (step S1024). More particularly, if the auxiliary sealing portion 42 of the protruding sealing element 4 is arranged upward, or the auxiliary sealing portion 42 is located above the main sealing portion 41 (that can be judged by the image recognition system S2 as shown in FIG. 3), the image recognition system S2 is configured to determine the placement orientation of the protruding sealing element 4 is correct. Moreover, if the auxiliary sealing portion 42 of the protruding sealing element 4 is arranged downward, or the auxiliary sealing portion 42 is located below the main sealing portion 41 (that is to say, when the auxiliary sealing portion 42 as shown in FIG. 3 is inverted, the placement orientation of the protruding sealing element 4 can be judged by the image recognition system S2 as shown in FIG. 3), the image recognition system S2 is configured to determine the placement orientation of the protruding sealing element 4 is wrong. Therefore, if the image recognition system S2 is configured to determine the placement orientation of the protruding sealing element 4 is wrong, the protruding sealing element 4 is turned over by 180 degrees, and then the step S102 of determining whether the placement orientation of the protruding sealing element 4 is correct is performed again (for example, at least including the step S1022 of using the image capture system S1 and the step S1024 of using the image recognition system S2). However, the aforementioned details are disclosed for exemplary purposes only, and are not meant to limit the scope of the present disclosure.

For example, referring to FIG. 1, FIG. 3, FIG. 4 and FIG. 5, in the step S104 of passing the protruding sealing element 4 in the correct placement orientation by the first conductive pin 21 and the second conductive pin 22 of the conductive assembly 2, both the first conductive pin 21 and the second conductive pin 22 of the conductive assembly 2 pass through the main sealing portion 41 and the auxiliary sealing portion 42 of the protruding sealing element 4 in sequence until the protruding sealing element 4 is completely accommodated inside a package casing 1. Moreover, in the step S104, as shown in FIG. 5, the first conductive pin 21 includes a first embedded portion 211 accommodated inside the package casing 3 and covered by the protruding sealing element 4, and a first exposed portion 212 exposed outside the package casing 3, and the second conductive pin 22 includes a second embedded portion 221 accommodated inside the package casing 3 and covered by the protruding sealing element 4, and a second exposed portion 222 exposed outside the package casing 3. It should be noted that, as shown in FIG. 5, the package casing 3 has an opening 3000, and the protruding sealing element 4 is disposed at the opening 3000 of the package casing 3 so as to close (or completely cover) the opening 3000 of the package casing 3. However, the aforementioned details are disclosed for exemplary purposes only, and are not meant to limit the scope of the present disclosure.

For example, referring to FIG. 4 and FIG. 5, the first embedded portion 211 of the first conductive pin 21 has a first large-diameter section 211D covered (or enclosed) by the main sealing portion 41 of the protruding sealing element 4, and a first small-diameter section 211d covered (or enclosed) by the auxiliary sealing portion 42 of the protruding sealing element 4. It should be noted that, the first large-diameter section 211D of the first embedded portion 211 extends from the wound assembly 1, the first small-diameter section 211d is connected between the first large-diameter section 211D and the first exposed portion 212, and a diameter of the first large-diameter section 211D is larger than a diameter of the first small-diameter section 211d. Moreover, the second embedded portion 221 of the second conductive pin 22 has a second large-diameter section 221D covered (or enclosed) by the main sealing portion 41 of the protruding sealing element 4, and a second small-diameter section 221d covered (or enclosed) by the auxiliary sealing portion 42 of the protruding sealing element 4. It should be noted that, the second large-diameter section 221D of the second embedded portion 221 extends from the wound assembly 1, the second small-diameter section 221d is connected between the second large-diameter section 221D and the second exposed portion 222, and a diameter of the second large-diameter section 221D is larger than a diameter of the second small-diameter section 221d. However, the aforementioned details are disclosed for exemplary purposes only, and are not meant to limit the scope of the present disclosure.

For example, referring to FIG. 3 and FIG. 4, the main sealing portion 41 has a first large-diameter through hole 4101, and the auxiliary sealing portion 42 has a first small-diameter through hole 4201 communicated with the first large-diameter through hole 4101. More particularly, an inner diameter of the first large-diameter through hole 4101 of the main sealing portion 41 is larger than an inner diameter of the first small-diameter through hole 4201 of the auxiliary sealing portion 42, and the first large-diameter through hole 4101 of the main sealing portion 41 and the first small-diameter through hole 4201 of the auxiliary sealing portion 42 are respectively configured to accommodate the first large-diameter section 211D and the first small-diameter section 211d of the first embedded portion 211. It should be noted that as shown in FIG. 4, the diameter of the first large-diameter section 211D of the first embedded portion 211 is larger than the inner diameter of the first small-diameter through hole 4201 of the auxiliary sealing portion 42, so that the first large-diameter section 211D of the first embedded portion 211 cannot be inserted into the first small-diameter through hole 4201 of the auxiliary sealing portion 42, but is blocked outside the first small-diameter through hole 4201 of the auxiliary sealing portion 42. Therefore, the first small-diameter through hole 4201 of the auxiliary sealing portion 42 can provide a limiting effect to the first large-diameter section 211D. However, the aforementioned details are disclosed for exemplary purposes only, and are not meant to limit the scope of the present disclosure.

For example, referring to FIG. 3 and FIG. 4, the main sealing portion 41 has a second large-diameter through hole 4102, and the auxiliary sealing portion 42 has a second small-diameter through hole 4202 communicated with the second large-diameter through hole 4102. More particularly, an inner diameter of the second large-diameter through hole 4102 of the main sealing portion 41 is larger than an inner diameter of the second small-diameter through hole 4202 of the auxiliary sealing portion 42, and the second large-diameter through hole 4102 of the main sealing portion 41 and the second small-diameter through hole 4202 of the auxiliary sealing portion 42 are respectively configured to accommodate the second large-diameter section 221D and the second small-diameter section 221d of the second embedded portion 221. It should be noted that as shown in FIG. 4, the diameter of the second large-diameter section 221D of the second embedded portion 221 is larger than the inner diameter of the second small-diameter through hole 4202 of the auxiliary sealing portion 42, so that the second large-diameter section 221D of the second embedded portion 221 cannot be inserted into the second small-diameter through hole 4202 of the auxiliary sealing portion 42, but is blocked outside the second small-diameter through hole 4202 of the auxiliary sealing portion 42. Therefore, the second small-diameter through hole 4202 of the auxiliary sealing portion 42 can provide a limiting effect to the second large-diameter section 221D. However, the aforementioned details are disclosed for exemplary purposes only, and are not meant to limit the scope of the present disclosure.

It should be noted that, for example, as shown in FIG. 6, the auxiliary sealing portion 42 of the protruding sealing element 4 does not be pressed by the surrounding concave position-limiting portion 31 of the package casing 3 and does not contact the surrounding convex end portion 32 of the package casing 3, so that the main sealing portion 41 of the protruding sealing element 4 can be deformed through the package casing 3, and the auxiliary sealing portion 42 of the protruding sealing element 4 cannot be deformed through the package casing 3. Moreover, in another possible embodiment, the auxiliary sealing portion 42 of the protruding sealing element 4 can also contact the surrounding convex end portion 32 of the package casing 3, so that the main sealing portion 41 and the auxiliary sealing portion 42 of the protruding sealing element 4 can be deformed through the package casing 3. In addition, a maximum height H1 of the auxiliary sealing portion 42 relative to the main sealing portion 41 is less than or equal to (flush with each other) a maximum height H2 of the surrounding convex end portion 32 relative to the main sealing portion 41. However, the aforementioned details are disclosed for exemplary purposes only, and are not meant to limit the scope of the present disclosure.

It should be noted that, for example, as shown in FIG. 6, a minimum width W1 of the surrounding convex end portion 32 of the package casing 3 is smaller than a maximum width W2 of the auxiliary sealing portion 42 of the protruding sealing element 4, so that the auxiliary sealing portion 42 of the protruding sealing element 4 does not contact the surrounding convex end portion 32 of the package casing 3. Moreover, a thickness T1 of the main sealing portion 41 of the protruding sealing element 4 is greater than a thickness T2 of the auxiliary sealing portion 42 of the protruding sealing element 4, and the surrounding convex end portion 32 of the package casing 3 is closer to the auxiliary sealing portion 42 of the protruding sealing element 4 than the surrounding concave position-limiting portion 31 of the package casing 3. Furthermore, the surrounding convex end portion 32 of the package casing 3 is surroundingly disposed on the main sealing portion 41 of the protruding sealing element 4 to form a recessed space 3200, and the auxiliary sealing portion 42 of the protruding sealing element 4 is completely accommodated inside the recessed space 3200 to occupy 70% to 100% of the recessed space 3200 (for example, when the recessed space 3200 is completely occupied by the auxiliary sealing portion 42 of the protruding sealing element 4, the auxiliary sealing portion 42 of the protruding sealing element 4 will contact the surrounding convex end portion 32 of the package casing 3). In addition, the main sealing portion 41 of the protruding sealing element 4 is closer to the wound assembly 1 than the auxiliary sealing portion 42 of the protruding sealing element 4, so that a height h1 of the main sealing portion 41 of the protruding sealing element 4 relative to the wound assembly 1 is smaller than a height h2 of the auxiliary sealing portion 42 of the protruding sealing element 4 relative to the wound assembly 1. However, the aforementioned details are disclosed for exemplary purposes only, and are not meant to limit the scope of the present disclosure.

### Second Embodiment

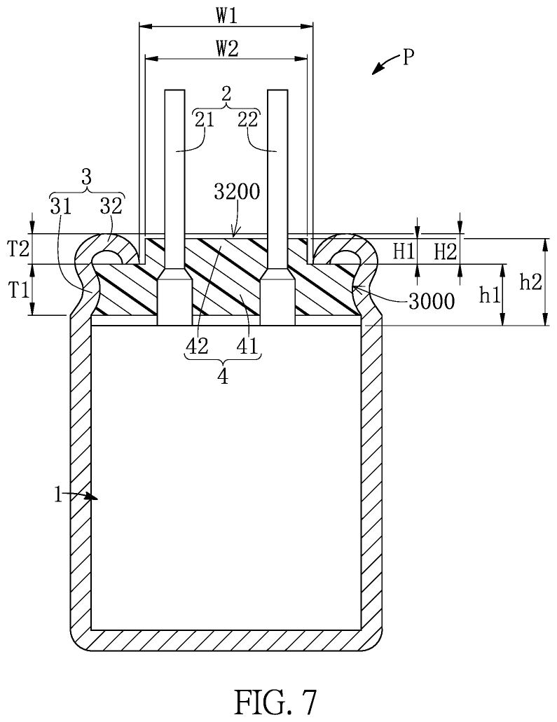

Referring to FIG. 7, a second embodiment of the present disclosure provides a wound capacitor package structure P, which includes a wound assembly 1, a conductive assembly 2, a package casing 3 and a protruding sealing element 4. Comparing FIG. 7 with FIG. 6, the main difference between the second embodiment and the first embodiment is as follows: in the second embodiment, when both the first conductive pin 21 and the second conductive pin 22 of the conductive assembly 2 pass through the main sealing portion 41 and the auxiliary sealing portion 42 of the protruding sealing element 4 in sequence, the protruding sealing element 4 may not be in contact with the wound assembly 1.

### Beneficial Effects of the Embodiments

In conclusion, in the wound capacitor package structure P provided by the present disclosure, by virtue of “the package casing 3 having a surrounding concave position-limiting portion 31 recessed inward to press the protruding sealing element 4, and a surrounding convex end portion 32 protruding from the surrounding concave position-limiting portion 31 to abut against the protruding sealing element 4” and “the protruding sealing element 4 having a main sealing portion 41 pressed by the surrounding concave position-limiting portion 31 and abutted by the surrounding convex end portion 32, and an auxiliary sealing portion 42 protruding from the main sealing portion 41 and surrounded by the surrounding convex end portion 32,” the auxiliary sealing portion 42 can provide an additional thickness T1 to the protruding sealing element 4 (that is to say, the total thickness T1 of the protruding sealing element 4 includes the thickness T1 of the main sealing portion 41 and the thickness T1 of the auxiliary sealing portion 42), whereby the wound capacitor package structure P has higher heat resistance during the reflow process due to the protection of the protruding sealing element 4 (that is to say, the wound assembly 1 has higher heat resistance during the reflow process due to the protection of the protruding sealing element 4). It is worth noting that when the thickness T1 of the main sealing portion 41 is reduced, the auxiliary sealing portion 42 can still provide sufficient thickness T1, so that the overall height h1 of the wound capacitor package structure P (or the overall height h1 of the package casing 3) can be reduced.

Furthermore, in the method of manufacturing the wound capacitor package structure P provided by the present disclosure, by virtue of “determining whether a placement orientation of a protruding sealing element 4 is correct,” “passing the protruding sealing element 4 in the correct placement orientation by the first conductive pin 21 and the second conductive pin 22 of the conductive assembly 2 until the protruding sealing element 4 is completely accommodated inside a package casing 3,” “the package casing 3 having a surrounding concave position-limiting portion 31 recessed inward to press the protruding sealing element 4, and a surrounding convex end portion 32 protruding from the surrounding concave position-limiting portion 31 to abut against the protruding sealing element 4” and “the protruding sealing element 4 having a main sealing portion 41 pressed by the surrounding concave position-limiting portion 31 and abutted by the surrounding convex end portion 32, and an auxiliary sealing portion 42 protruding from the main sealing portion 41 and surrounded by the surrounding convex end portion 32,” the auxiliary sealing portion 42 can provide an additional thickness T1 to the protruding sealing element 4 (that is to say, the total thickness T1 of the protruding sealing element 4 includes the thickness T1 of the main sealing portion 41 and the thickness T1 of the auxiliary sealing portion 42), whereby the wound capacitor package structure P has higher heat resistance during the reflow process due to the protection of the protruding sealing element 4 (that is to say, the wound assembly 1 has higher heat resistance during the reflow process due to the protection of the protruding sealing element 4). It is worth noting that when the thickness T1 of the main sealing portion 41 is reduced, the auxiliary sealing portion 42 can still provide sufficient thickness T1, so that the overall height h1 of the wound capacitor package structure P (or the overall height h1 of the package casing 3) can be reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A wound capacitor package structure, comprising:
a wound assembly including a wound positive conductive foil, a wound negative conductive foil and two wound insulating separators;
a conductive assembly including a first conductive pin electrically contacting the wound positive conductive foil and a second conductive pin electrically contacting the wound negative conductive foil;
a package casing configured to receive the wound assembly; and
a protruding sealing element disposed inside the package casing and cooperating with the package casing;
wherein one of the two wound insulating separators is disposed between the wound positive conductive foil and the wound negative conductive foil, and one of the wound positive conductive foil and the wound negative conductive foil is disposed between the two wound insulating separators;
wherein the first conductive pin includes a first embedded portion accommodated inside the package casing and covered by the protruding sealing element, and a first exposed portion exposed outside the package casing, and the second conductive pin includes a second embedded portion accommodated inside the package casing and covered by the protruding sealing element, and a second exposed portion exposed outside the package casing;
wherein the package casing has a surrounding concave position-limiting portion recessed inward to press the protruding sealing element, and a surrounding convex end portion protruding from the surrounding concave position-limiting portion to abut against the protruding sealing element;
wherein the protruding sealing element has a main sealing portion pressed by the surrounding concave position-limiting portion and abutted by the surrounding convex end portion, and an auxiliary sealing portion protruding from the main sealing portion and surrounded by the surrounding convex end portion;
wherein a maximum height of the auxiliary sealing portion relative to the main sealing portion is less than or equal to a maximum height of the surrounding convex end portion relative to the main sealing portion.

2. The wound capacitor package structure according to claim 1,
wherein the package casing has an opening, and the protruding sealing element is disposed at the opening of the package casing so as to close the opening of the package casing;
wherein the auxiliary sealing portion of the protruding sealing element does not be pressed by the surrounding concave position-limiting portion of the package casing and does not contact the surrounding convex end portion of the package casing, so that the main sealing portion of the protruding sealing element is deformed through the package casing, and the auxiliary sealing portion of the protruding sealing element is not deformed through the package casing;
wherein a minimum width of the surrounding convex end portion of the package casing is smaller than a maximum width of the auxiliary sealing portion of the protruding sealing element;
wherein a thickness of the main sealing portion of the protruding sealing element is greater than a thickness of the auxiliary sealing portion of the protruding sealing element;
wherein the surrounding convex end portion of the package casing is closer to the auxiliary sealing portion of the protruding sealing element than the surrounding concave position-limiting portion of the package casing;
wherein the surrounding convex end portion of the package casing is surroundingly disposed on the main sealing portion of the protruding sealing element to form a recessed space, and the auxiliary sealing portion of the protruding sealing element is completely accommodated inside the recessed space to occupy 70% to 100% of the recessed space;
wherein the main sealing portion of the protruding sealing element is closer to the wound assembly than the auxiliary sealing portion of the protruding sealing element, so that a height of the main sealing portion of the protruding sealing element relative to the wound assembly is smaller than a height of the auxiliary sealing portion of the protruding sealing element relative to the wound assembly.

3. The wound capacitor package structure according to claim 1,
wherein the first embedded portion of the first conductive pin has a first large-diameter section covered by the main sealing portion of the protruding sealing element, and a first small-diameter section covered by the auxiliary sealing portion of the protruding sealing element, the first large-diameter section of the first embedded portion extends from the wound assembly, the first small-diameter section is connected between the first large-diameter section and the first exposed portion, and a diameter of the first large-diameter section is larger than a diameter of the first small-diameter section;
wherein the second embedded portion of the second conductive pin has a second large-diameter section covered by the main sealing portion of the protruding sealing element, and a second small-diameter section covered by the auxiliary sealing portion of the protruding sealing element, the second large-diameter section of the second embedded portion extends from the wound assembly, the second small-diameter section is connected between the second large-diameter section and the second exposed portion, and a diameter of the second large-diameter section is larger than a diameter of the second small-diameter section;
wherein the main sealing portion has a first large-diameter through hole, the auxiliary sealing portion has a first small-diameter through hole communicated with the first large-diameter through hole, an inner diameter of the first large-diameter through hole of the main sealing portion is larger than an inner diameter of the first small-diameter through hole of the auxiliary sealing portion, the first large-diameter through hole of the main sealing portion and the first small-diameter through hole of the auxiliary sealing portion are respectively configured to accommodate the first large-diameter section and the first small-diameter section of the first embedded portion, and the diameter of the first large-diameter section of the first embedded portion is larger than the inner diameter of the first small-diameter through hole of the auxiliary sealing portion, so that the first large-diameter section of the first embedded portion is unable to be inserted into the first small-diameter through hole of the auxiliary sealing portion and is blocked outside the first small-diameter through hole of the auxiliary sealing portion;
wherein the main sealing portion has a second large-diameter through hole, the auxiliary sealing portion has a second small-diameter through hole communicated with the second large-diameter through hole, an inner diameter of the second large-diameter through hole of the main sealing portion is larger than an inner diameter of the second small-diameter through hole of the auxiliary sealing portion, the second large-diameter through hole of the main sealing portion and the second small-diameter through hole of the auxiliary sealing portion are respectively configured to accommodate the second large-diameter section and the second small-diameter section of the second embedded portion, and the diameter of the second large-diameter section of the second embedded portion is larger than the inner diameter of the second small-diameter through hole of the auxiliary sealing portion, so that the second large-diameter section of the second embedded portion is unable to be inserted into the second small-diameter through hole of the auxiliary sealing portion and is blocked outside the second small-diameter through hole of the auxiliary sealing portion.

4. A wound capacitor package structure, comprising:
a wound assembly;
a conductive assembly including a first conductive pin electrically contacting the wound assembly and a second conductive pin electrically contacting the wound assembly;
a package casing configured to receive the wound assembly; and
a protruding sealing element disposed inside the package casing and cooperating with the package casing;
wherein the package casing has a surrounding concave position-limiting portion recessed inward to press the protruding sealing element, and a surrounding convex end portion protruding from the surrounding concave position-limiting portion to abut against the protruding sealing element;
wherein the protruding sealing element has a main sealing portion pressed by the surrounding concave position-limiting portion and abutted by the surrounding convex end portion, and an auxiliary sealing portion protruding from the main sealing portion and surrounded by the surrounding convex end portion.

5. The wound capacitor package structure according to claim 4,
wherein the package casing has an opening, and the protruding sealing element is disposed at the opening of the package casing so as to close the opening of the package casing;
wherein the auxiliary sealing portion of the protruding sealing element does not be pressed by the surrounding concave position-limiting portion of the package casing and does not contact the surrounding convex end portion of the package casing, so that the main sealing portion of the protruding sealing element is deformed through the package casing, and the auxiliary sealing portion of the protruding sealing element is not deformed through the package casing;
wherein a minimum width of the surrounding convex end portion of the package casing is smaller than a maximum width of the auxiliary sealing portion of the protruding sealing element;
wherein a thickness of the main sealing portion of the protruding sealing element is greater than a thickness of the auxiliary sealing portion of the protruding sealing element;
wherein the surrounding convex end portion of the package casing is closer to the auxiliary sealing portion of the protruding sealing element than the surrounding concave position-limiting portion of the package casing;
wherein the surrounding convex end portion of the package casing is surroundingly disposed on the main sealing portion of the protruding sealing element to form a recessed space, and the auxiliary sealing portion of the protruding sealing element is completely accommodated inside the recessed space to occupy 70% to 100% of the recessed space;
wherein the main sealing portion of the protruding sealing element is closer to the wound assembly than the auxiliary sealing portion of the protruding sealing element, so that a height of the main sealing portion of the protruding sealing element relative to the wound assembly is smaller than a height of the auxiliary sealing portion of the protruding sealing element relative to the wound assembly;
wherein a maximum height of the auxiliary sealing portion relative to the main sealing portion is less than or equal to a maximum height of the surrounding convex end portion relative to the main sealing portion.

6. The wound capacitor package structure according to claim 4,
wherein the first conductive pin includes a first embedded portion accommodated inside the package casing and covered by the protruding sealing element, and a first exposed portion exposed outside the package casing, and the second conductive pin includes a second embedded portion accommodated inside the package casing and covered by the protruding sealing element, and a second exposed portion exposed outside the package casing;
wherein the first embedded portion of the first conductive pin has a first large-diameter section covered by the main sealing portion of the protruding sealing element, and a first small-diameter section covered by the auxiliary sealing portion of the protruding sealing element, the first large-diameter section of the first embedded portion extends from the wound assembly, the first small-diameter section is connected between the first large-diameter section and the first exposed portion, and a diameter of the first large-diameter section is larger than a diameter of the first small-diameter section;
wherein the second embedded portion of the second conductive pin has a second large-diameter section covered by the main sealing portion of the protruding sealing element, and a second small-diameter section covered by the auxiliary sealing portion of the protruding sealing element, the second large-diameter section of the second embedded portion extends from the wound assembly, the second small-diameter section is connected between the second large-diameter section and the second exposed portion, and a diameter of the second large-diameter section is larger than a diameter of the second small-diameter section;
wherein the main sealing portion has a first large-diameter through hole, the auxiliary sealing portion has a first small-diameter through hole communicated with the first large-diameter through hole, an inner diameter of the first large-diameter through hole of the main sealing portion is larger than an inner diameter of the first small-diameter through hole of the auxiliary sealing portion, the first large-diameter through hole of the main sealing portion and the first small-diameter through hole of the auxiliary sealing portion are respectively configured to accommodate the first large-diameter section and the first small-diameter section of the first embedded portion, and the diameter of the first large-diameter section of the first embedded portion is larger than the inner diameter of the first small-diameter through hole of the auxiliary sealing portion, so that the first large-diameter section of the first embedded portion is unable to be inserted into the first small-diameter through hole of the auxiliary sealing portion and is blocked outside the first small-diameter through hole of the auxiliary sealing portion;
wherein the main sealing portion has a second large-diameter through hole, the auxiliary sealing portion has a second small-diameter through hole communicated with the second large-diameter through hole, an inner diameter of the second large-diameter through hole of the main sealing portion is larger than an inner diameter of the second small-diameter through hole of the auxiliary sealing portion, the second large-diameter through hole of the main sealing portion and the second small-diameter through hole of the auxiliary sealing portion are respectively configured to accommodate the second large-diameter section and the second small-diameter section of the second embedded portion, and the diameter of the second large-diameter section of the second embedded portion is larger than the inner diameter of the second small-diameter through hole of the auxiliary sealing portion, so that the second large-diameter section of the second embedded portion is unable to be inserted into the second small-diameter through hole of the auxiliary sealing portion and is blocked outside the second small-diameter through hole of the auxiliary sealing portion.

7. A method of manufacturing a wound capacitor package structure, comprising:
providing a wound assembly and a conductive assembly, wherein the conductive assembly includes a first conductive pin electrically contacting the wound assembly and a second conductive pin electrically contacting the wound assembly;
determining whether a placement orientation of a protruding sealing element is correct;
passing the protruding sealing element in the correct placement orientation by the first conductive pin and the second conductive pin of the conductive assembly, and completely accommodating the wound assembly and the protruding sealing element inside a package casing; and
changing a shape of the package casing so as to allow the package casing to cooperate with the protruding sealing element;
wherein the package casing has a surrounding concave position-limiting portion recessed inward to press the protruding sealing element, and a surrounding convex end portion protruding from the surrounding concave position-limiting portion to abut against the protruding sealing element;
wherein the protruding sealing element has a main sealing portion pressed by the surrounding concave position-limiting portion and abutted by the surrounding convex end portion, and an auxiliary sealing portion protruding from the main sealing portion and surrounded by the surrounding convex end portion.

8. The method of manufacturing the wound capacitor package structure according to claim 7, the step of determining whether the placement orientation of the protruding sealing element is correct further comprises:
by an image capture system, capturing an image of the protruding sealing element; and
by an image recognition system, determining whether the auxiliary sealing portion of the protruding sealing element is arranged upward or downward, or determining whether the auxiliary sealing portion is located above the main sealing portion or below the main sealing portion;
wherein, if the auxiliary sealing portion of the protruding sealing element is arranged upward, or the auxiliary sealing portion is located above the main sealing portion, the image recognition system is configured to determine the placement orientation of the protruding sealing element is correct;
wherein, if the auxiliary sealing portion of the protruding sealing element is arranged downward, or the auxiliary sealing portion is located below the main sealing portion, the image recognition system is configured to determine the placement orientation of the protruding sealing element is wrong;
wherein, if the image recognition system is configured to determine the placement orientation of the protruding sealing element is wrong, the protruding sealing element is turned over by 180 degrees, and then the step of determining whether the placement orientation of the protruding sealing element is correct is performed again;
wherein, in the step of passing the protruding sealing element in the correct placement orientation by the first conductive pin and the second conductive pin of the conductive assembly, both the first conductive pin and the second conductive pin of the conductive assembly pass through the main sealing portion and the auxiliary sealing portion of the protruding sealing element in sequence.

9. The method of manufacturing the wound capacitor package structure according to claim 7,
wherein the package casing has an opening, and the protruding sealing element is disposed at the opening of the package casing so as to close the opening of the package casing;
wherein the auxiliary sealing portion of the protruding sealing element does not be pressed by the surrounding concave position-limiting portion of the package casing and does not contact the surrounding convex end portion of the package casing, so that the main sealing portion of the protruding sealing element is deformed through the package casing, and the auxiliary sealing portion of the protruding sealing element is not deformed through the package casing;
wherein a minimum width of the surrounding convex end portion of the package casing is smaller than a maximum width of the auxiliary sealing portion of the protruding sealing element;
wherein a thickness of the main sealing portion of the protruding sealing element is greater than a thickness of the auxiliary sealing portion of the protruding sealing element;
wherein the surrounding convex end portion of the package casing is closer to the auxiliary sealing portion of the protruding sealing element than the surrounding concave position-limiting portion of the package casing;
wherein the surrounding convex end portion of the package casing is surroundingly disposed on the main sealing portion of the protruding sealing element to form a recessed space, and the auxiliary sealing portion of the protruding sealing element is completely accommodated inside the recessed space to occupy 70% to 100% of the recessed space;
wherein the main sealing portion of the protruding sealing element is closer to the wound assembly than the auxiliary sealing portion of the protruding sealing element, so that a height of the main sealing portion of the protruding sealing element relative to the wound assembly is smaller than a height of the auxiliary sealing portion of the protruding sealing element relative to the wound assembly;
wherein a maximum height of the auxiliary sealing portion relative to the main sealing portion is less than or equal to a maximum height of the surrounding convex end portion relative to the main sealing portion.

10. The method of manufacturing the wound capacitor package structure according to claim 7,
wherein the first conductive pin includes a first embedded portion accommodated inside the package casing and covered by the protruding sealing element, and a first exposed portion exposed outside the package casing, and the second conductive pin includes a second embedded portion accommodated inside the package casing and covered by the protruding sealing element, and a second exposed portion exposed outside the package casing;
wherein the first embedded portion of the first conductive pin has a first large-diameter section covered by the main sealing portion of the protruding sealing element, and a first small-diameter section covered by the auxiliary sealing portion of the protruding sealing element, the first large-diameter section of the first embedded portion extends from the wound assembly, the first small-diameter section is connected between the first large-diameter section and the first exposed portion, and a diameter of the first large-diameter section is larger than a diameter of the first small-diameter section;
wherein the second embedded portion of the second conductive pin has a second large-diameter section covered by the main sealing portion of the protruding sealing element, and a second small-diameter section covered by the auxiliary sealing portion of the protruding sealing element, the second large-diameter section of the second embedded portion extends from the wound assembly, the second small-diameter section is connected between the second large-diameter section and the second exposed portion, and a diameter of the second large-diameter section is larger than a diameter of the second small-diameter section;
wherein the main sealing portion has a first large-diameter through hole, the auxiliary sealing portion has a first small-diameter through hole communicated with the first large-diameter through hole, an inner diameter of the first large-diameter through hole of the main sealing portion is larger than an inner diameter of the first small-diameter through hole of the auxiliary sealing portion, the first large-diameter through hole of the main sealing portion and the first small-diameter through hole of the auxiliary sealing portion are respectively configured to accommodate the first large-diameter section and the first small-diameter section of the first embedded portion, and the diameter of the first large-diameter section of the first embedded portion is larger than the inner diameter of the first small-diameter through hole of the auxiliary sealing portion, so that the first large-diameter section of the first embedded portion is unable to be inserted into the first small-diameter through hole of the auxiliary sealing portion and is blocked outside the first small-diameter through hole of the auxiliary sealing portion;
wherein the main sealing portion has a second large-diameter through hole, the auxiliary sealing portion has a second small-diameter through hole communicated with the second large-diameter through hole, an inner diameter of the second large-diameter through hole of the main sealing portion is larger than an inner diameter of the second small-diameter through hole of the auxiliary sealing portion, the second large-diameter through hole of the main sealing portion and the second small-diameter through hole of the auxiliary sealing portion are respectively configured to accommodate the second large-diameter section and the second small-diameter section of the second embedded portion, and the diameter of the second large-diameter section of the second embedded portion is larger than the inner diameter of the second small-diameter through hole of the auxiliary sealing portion, so that the second large-diameter section of the second embedded portion is unable to be inserted into the second small-diameter through hole of the auxiliary sealing portion and is blocked outside the second small-diameter through hole of the auxiliary sealing portion.
